(19) United States
(12) Patent Application Publication
(10) Pub. No.: US 2007/0041544 A1
(43) Pub. Date: Feb. 22, 2007

(54) SYSTEM FOR THE APPLICATION AND REMOVAL OF INTERCOM TELEPHONE POWER UPON ACTIVATION OR DEACTIVATION OF TELEPHONE COMPANY SERVICE

(76) Inventor: David L. Oblad, San Bernardino, CA (US)

Correspondence Address: KLEIN, O'NEILL & SINGH, LLP, 43 CORPORATE PARK, SUITE 204, IRVINE, CA, 92606, US

(21) Appl. No.: 11/427,274

(22) Filed: Jun. 28, 2006

Related U.S. Application Data
(60) Provisional application No. 60/694,771, filed on Jun. 28, 2005.

(51) Int. Cl. H04M 1/00; H04M 9/00

(52) U.S. Cl. 379/159; 379/399.01

(57) ABSTRACT

A system and method is provided for automatically connecting and disconnecting alternative power to intercom telephones without interfering or interacting with the power supplied or cancelled by the telephone company central office. Central Office power is continuously monitored by a sensing circuit to determine whether the service to that telephone is being activated or deactivated by the Central Office. When no Central Office power is detected, the system automatically supplies alternative operating power to the telephone, enabling it to initiate intercom phone calls. When a resumption of Central Office service is detected, the power supplied by the system is removed, and the Central Office power is supplied to the telephone.

### CROSS-REFERENCE TO RELATED APPLICATION

This application claims the benefit, under 35 U.S.C. § 119(e), of co-pending Provisional Application No. 60/694,771, Filed Jun. 28, 2005, the disclosure of which is incorporated herein by reference.

### FEDERALLY-SPONSORED RESEARCH OR DEVELOPMENT

Not Applicable

### BACKGROUND OF THE INVENTION

The present invention relates generally to telephony, and more particularly to commercial intercom telephone systems with a “Call Down” feature. Additionally, this invention relates to commercial intercom telephone systems where a resident has chosen not to have traditional telephone services, but instead utilizes the standard building telephone wiring in order to be connected to a building intercom service. Even more specifically, this invention relates to telephone systems in which an intercom service is provided, and the resident telephone requires power in order to operate, and where there is also a requirement for this power to be automatically applied or removed when standard telephone service is activated or cancelled.

No-phone-charge intercom systems in multi-resident buildings have existed for many years. The two primary systems are “hard wired” and “telephone intercoms”. The telephone intercom systems utilize the standard telephone wiring to each resident, so that the resident's standard telephone is used for both standard telephone service and intercom service. The primary function of the intercom system is to allow internal building communication in multi-resident structures without incurring charges from the telephone company. Currently there are two main types of telephone intercom systems. The first type is a “call up” telephone intercom system where the subscriber uses a telephone to provide visitors entry into the building without having to walk to the entrance and open the door. The second type is the “call up and call down” system where the subscriber not only uses a telephone to provide visitors entry into the building, but can also use the telephone to call down to another station to initiate an intercom telephone call with a limited number of door attendant/concierge/valet/management office telephones. Intercoms that allow the resident to initiate an intercom call require that the resident's telephone have a minimum operating voltage on its telephone line. Traditionally, a telephone company Central Office (CO) supplies this operating voltage.

With the increasing popularity of cellular and broadband telephone services, it is becoming more commonplace for multiple resident buildings to have various forms of telephone services. If the resident is only using cellular telephone service, the intercom telephone system will no longer be supplied power from the CO. In order for the intercom call to be initiated by the resident, the resident's telephone must continually have a minimum amount of operating voltage across the phone line.

In view of the above, a need exists for a system and method for connecting or disconnecting an alternative operating voltage power source to the resident phone line circuitry when needed.

### SUMMARY OF THE INVENTION

The general objective of the present invention is to provide an automatic fail safe method of connecting or disconnecting alternative power to standard resident telephones without interfering or interacting with the power supplied or cancelled by the telephone company central office. The method is implemented by an automated system in which an intercom power application is provided to supply an alternative operating voltage to resident telephone lines.

The system includes a microprocessor, an alternative power source, a plurality of “voltage and current sensing circuits,” and a plurality of voltage selection switches. A voltage and current sensing circuit is individually coupled to each resident telephone line to monitor voltage and current levels provided by the telephone company central office. The microprocessor controls the voltage selection switches to connect or disconnect the alternative power source to and from the resident telephone line. The operation of the voltage selecting switches is based on signals received from the voltage and current sensing circuits. The microprocessor assures the proper timing of switching.

This brief summary has been provided so that the nature of the invention may be understood quickly. A more complete understanding of the invention can be obtained by reference to the following detailed description of the preferred embodiments thereof in connection with the attached drawings. Detailed descriptions of known functions and configurations incorporated herein have been omitted for clarity and conciseness.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram showing the architecture of an intercom power application system in accordance with the present invention;

FIGS. 2A, 2B, and 2C are schematic diagrams illustrating exemplary circuit implementations of the alternative power source, the microprocessor, and the sample timer, respectively, of the intercom power application system of FIG. 1;

FIG. 3 is a schematic diagram illustrating an exemplary circuit implementation of a current/voltage sensing circuit of the intercom power application system of FIG. 1; and

FIG. 4 is a flow chart illustrating the steps of a method for operating the intercom power application system of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to the present invention, a system and method for automatically connecting and disconnecting an alternative power source to and from intercom telephone lines is provided. Although the system and method of the present invention is described as being implemented in a multi-resident building, those skilled in the art will recognize that the principles and teachings described herein may be applied to a variety of structures using a commercial intercom telephone system, such as a hotel or ship.

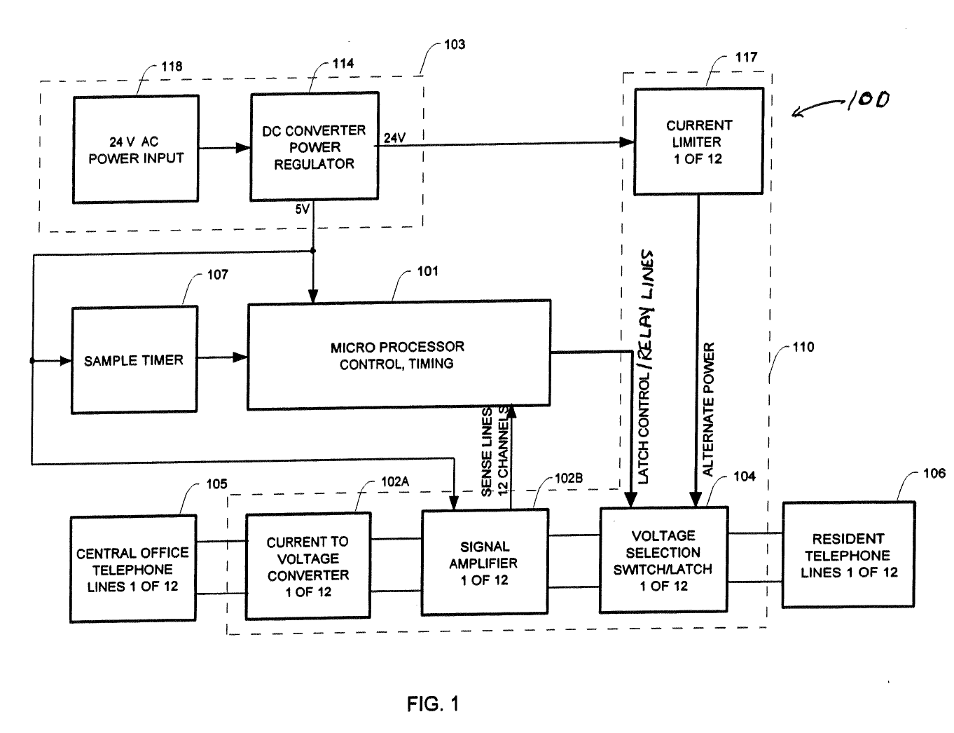

Turning to FIG. 1, a functional block diagram of an intercom power application system 100 that can be applied to both “call up” systems and “call up and call down” systems is shown. In a preferred embodiment of the present invention, the system 100 comprises an alternative power source 103 that, as will be described below, provides an alternative 24V DC power source for operating the intercom system. The power source 103 also supplies a 5V DC operating voltage to the components of the intercom power application system 100 of the present invention, which includes a microprocessor 101 providing operational control, a sample timer 107 controlling sampling rate, and a plurality of voltage/current sensing circuits 110. A separate voltage/current sensing circuit 110 is connected to each resident telephone line 106 for sensing whether an operating voltage is provided by the CO. FIG. 1 illustrates a representative voltage/current sensing circuit 110. Although 12 resident telephone lines are shown, the system can have more or less resident telephone lines. If the CO is not providing the operating voltage, the alternative power source 103 provides 24V DC as an alternative intercom operating power source that is disconnected automatically when the CO power is restored, as discussed below.

Telephone lines 105 from the CO are input into the voltage/current sensing circuit 10 which comprises a current-to-voltage converter 102A for receiving a current signal from the CO and converting the current signal to a voltage signal, a signal amplifier 102B for amplifying the voltage signal, and a voltage selection switch/latch 104 for connecting and disconnecting the alternative power source 103 to the resident telephone line 106.

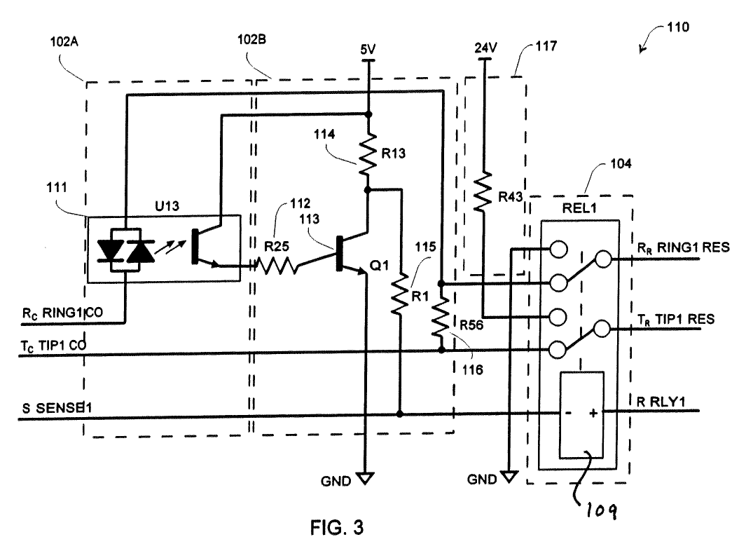

The alternative power source 103 comprises a 24V AC power supply 118 and a DC converter power regulator 114, such as a 78L05. The AC power supply 118 is conventional, and it may include a step-down transformer (not shown) that receives standard 110V AC voltage on its input side. The output of the AC power supply 118 is input into the DC converter power regulator 114, which converts the 24V AC to 24V DC. The 24V DC is then supplied to a current limiter 117, which, in turn, supplies a signal to the voltage selection switch 104, causing the switch to position itself so that the alternative power source is connected to the resident line 106. The microprocessor 101 continuously monitors the status of the operating voltage of the CO to the telephone line 106 by sampling the current flowing through an opto-coupler 111 (see FIG. 3) in the current to voltage converter 102A, using the sample timer 107, and stores the sampling results.

To ensure an accurate reading, the microprocessor 101 requires sixteen consecutive identical samples, with each sample taken at spaced intervals of approximately 3 seconds, before it initiates switching of the voltage selection switch 104. This finite impulse response (FIR) filter type is provided to prevent glitches and non-representative signal changes from triggering the activation of the voltage selection switch 104.

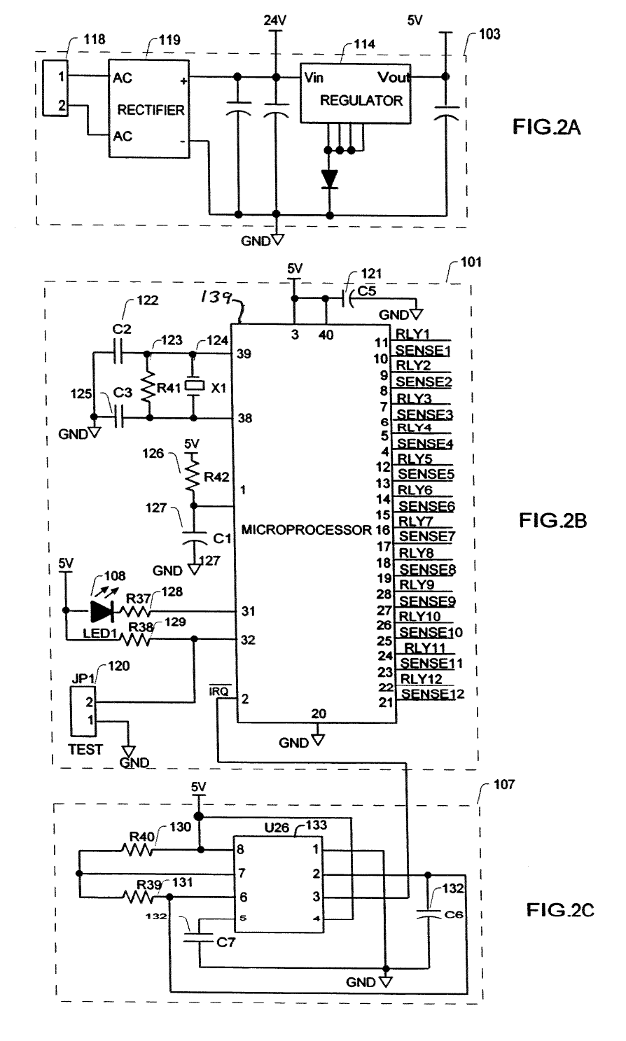

The sample timer 107 determines the sampling rate of the microprocessor 101 by sending a timing signal to the microprocessor 101 via the latter's IRQ port, causing the microprocessor 101 to restart CO line scans. A light emitting diode LED1 108 (such as a 1N914 as shown in FIG. 2B) is connected to an I/O port of the microprocessor 101. Flashing of the light emitting diode 108 indicates the sampling rate and scan activation to service personnel.

When the microprocessor 101 detects a change of CO power, it initiates a process to change the position of the voltage selection switch 104. This process includes changing the I/O configuration and asserting predetermined logic values to a relay coil terminal of the voltage selection switch 104, while observing a predetermined sequence of operation to avoid timing conflicts. Following a system power-up, the voltage selection switches 104 are in their default position, connecting CO power to a resident phone line 106. To change a voltage selection switch 104 from CO power to alternative power requires energizing the relay coil of the voltage selection switch by asserting logic “1” on a relay line (e.g., the line RLY1 in FIGS. 2B and 3) and logic “0” on a sense line (e.g., the line SENSE1 in FIGS. 2B and 3), energizing a relay 109 (FIG. 3) in the voltage selection switch 104 to perform switching. (The sense lines and relay lines are respectively labeled “SENSE LINES” and “RELAY LINES” in the block diagram of FIG. 1.) Once the switch 104 changes its position, it maintains that position until signal polarity changes on its relay coil.

As best shown in FIG. 3, in a non-CO power position, the voltage selection switch 104 disconnects CO lines from the resident telephone line 106 and connects the alternative 24V DC from the alternative power source 103 to its “Tip line” via a current limiting resistor R43 117, and it connects the “Ring line” to ground (GND). In this position, the resident phone is disconnected from the CO, while the current loop is maintained from the CO's “Ring line” to its “Tip line” through a serially connected opto-coupler 111 and a resistor R56 116. When CO power is restored, current in the current loop increases, turning transistor Q1 113 “on,” and asserts logic “0” on a “sense line,” thereby indicating the presence of CO power to the microprocessor 101.

FIG. 2A is a schematic diagram of the alternative power source 103. The alternative power source 103 includes a line transformer (not shown) providing 24V AC to a rectifier bridge 119 via a power input 118. The rectified 24V DC is used to provide the alternative voltage to each resident telephone line 106 via a current limiting resistor 117 (FIGS. 1 and 3). The 24V DC is converted further by a DC Converter 114 to supply 5V DC to the microprocessor 101, to the sample timer 107 and to the signal amplifier 102B in each of the sensing circuits 110 (one for each telephone line).

FIG. 2B is a schematic diagram of an exemplary implementation of the microprocessor 101. A MC68HC7059A Micro-Processor Unit (MPU) 139 or the equivalent, such as or a 68705C9 micro-controller, is preferably used in the present invention. The MPU 139 operates with 5V DC supplied by the alternative power source 103, with a capacitor C5 121 as a decoupling capacitor. A tank circuit formed by a 2 MHz quartz-crystal X1 124, a resistor R41 123, and capacitors C2 122 and C3 125, connected to pins 38 and 39 of the MPU 139 and sets the internal clock of the MPU 139 to 2 MHz. Power-on reset is applied to the MPU 139 by an RC network comprising a resistor R42 126 and a capacitor C1 127. The LED 108 is connected to an I/O port of the MPU 139 via a current limiting resistor R37 128. A pull-up resistor R38 129, connected to another I/O port of the MPU 139, allows the MPU 139 to recognize the IRQ signal. A jumper JP1 120 is advantageously provided, which, when shorted, results in IRQ requests being ignored. Furthermore, during a system test performed by shorting the jumper JP1 120, the microprocessor 101 is put into a continuous mode of operation, allowing for quick diagnostics.

FIG. 2C is a schematic diagram of an exemplary implementation of the sample timer circuit 107. The sample timer circuit 107 employs a timer U26 133, preferably an MC 1455 or LM555 timer or the equivalent. The timer 133 is operated with the 5V DC supply, using a capacitor C7 132 as a decoupling capacitor. Resistors R40 130 and R39 131, together with a capacitor C6 132, determine the cycle time of the timer circuit 107. The cycle time is calculated by Equation (1):
T_{cycle}=0.693×C6×(R40+2×R39) Equation (1):

The internal circuitry of each of the voltage/current sensing circuits 110 is illustrated in FIG. 3. During normal operation (i.e. the CO is supplying operating voltage to the resident lines 106), current from a CO Ring line R_{C} flows through a current loop back to a CO Tip line T_{C}. The current loop is formed by serially connecting the opto-coupler 111, such as a H11AA, one side of the voltage switch 104, and a resident telephone via resident Tip and Ring lines (T_{R} and R_{R}, respectively). The current loop is coupled to the signal amplifier 102B, comprised of a transistor Q1 113, such as a 2N2222, and a collector resistor R13, via a base resistor R25 112, for amplifying the current. The collector of the transistor Q1 113 is connected to an I/O port of the microprocessor 101 (shown in FIG. 2B) through a resistor R1 115 via a sense line S, asserting logic “0” indicating the presence of CO service, i.e. the resident telephone 106 is operating normally with CO provided power. When CO power is removed or unavailable, current flowing through the opto-coupler 111 decreases to a predetermined value (determined by the respective gains of the opto-coupler 111 and the transistor Q1), forcing the signal amplifier 102B to output a logic “1” on the sense line S, which is input to the microprocessor 101.

Table 1 below identifies the preferred values of the resistors and capacitors (described above) in a preferred embodiment of the present invention.

TABLE 1

| R1 | 20K | |
|---|---|---|
| R13 | 470K | |
| R25 | 100K | |
| R38 | 2K | |
| R39 | 220K | |
| R40 | 100K | |
| R41 | 10 | M |
| R42 | 10K | |
| R43 | 680 | ohms |
| R56 | 5.1 | M |
| C1 | 4.7 | uF |
| C2 | 33 | pF |
| C3 | 33 | pF |
| C5 | 4.7 | uF |
| C6 | 10 | uF |
| C7 | 0.1 | uF |

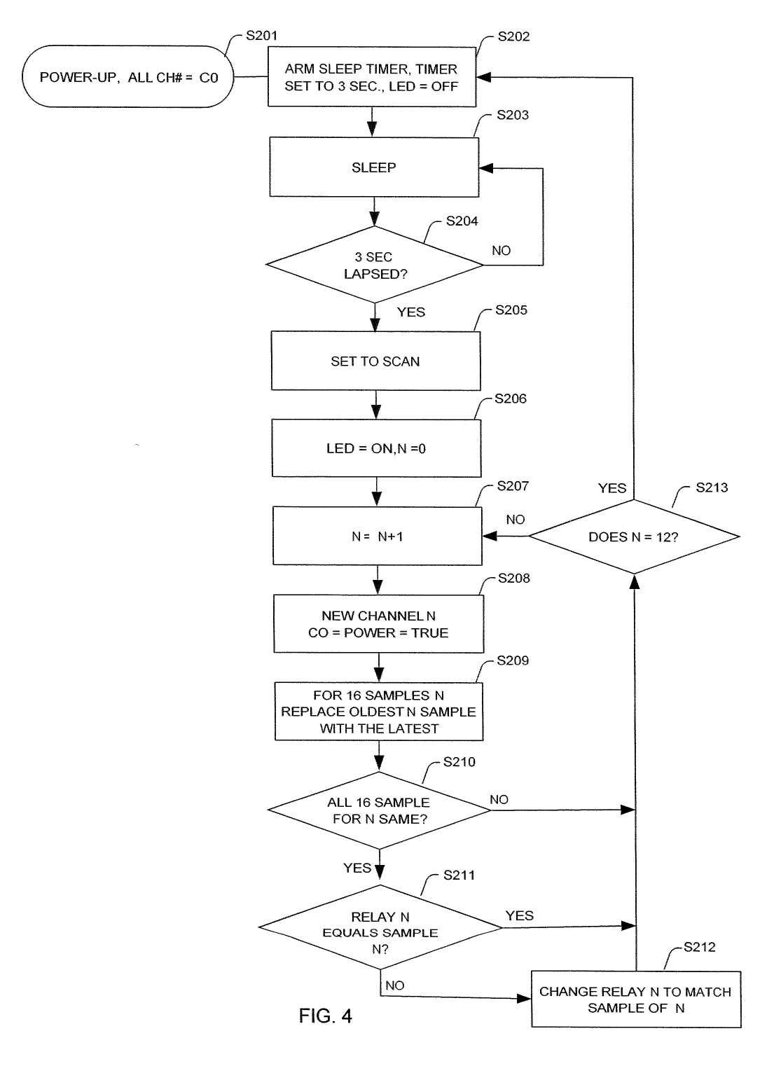

FIG. 4 is a process flowchart illustrating the steps of an automatic method for operating the intercom power application system 100 in accordance with the present invention. The operation of intercom power application system 100 is controlled by the microprocessor 101 (see FIG. 1) that manages the functions and timing of the intercom power application system 100. The microprocessor 101 stores and retrieves multiple data sets and the operating software that controls the system. In the following description only basic operations that are necessary to understand the automatic application or removal of alternative power are described.

In step S201, at first power up, the voltage selection switches 104 default all channels (e.g., twelve channels) to the CO mode.

In step S202, the sample timer 107 is armed (automatically reset), and the LED 108 indicator is turned off.

In steps S203 and S204, the system 100 is idling for 3 seconds.

In step S205, the telephone line sampling process begins, and the LED 108 indicator is turned on.

In steps S206 thru S209, lines are sampled sequentially, and the results of the last 16 samples for each of the twelve lines, designated as ‘N’ channels, get stored in the microprocessor 101.

In step S210, it is determined if the last 16 samples were all the same. If the samples were all the same, the process continues at step S211. Otherwise, the process proceeds to step S203 if the samples are inconsistent.

In step S211, it is determined if a change occurred in CO service status by testing it against the previous known state of the relay, such as a G6KU-2F in the voltage selection switch 104. If there is a change, the microprocessor 101 initiates switching of the appropriate voltage selection switch 104 in step S212. Otherwise, the process proceeds to step S213.

In step S212, a voltage selection switching is performed to match line service requirements.

In step S213, it is determined whether all 12 telephone lines were scanned. If scanning is incomplete, the next phone line is scanned in step S207. Otherwise, the process proceeds to step S202 to arm a new scan cycle.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An intercom power application system for providing power from an alternate power source to a plurality of resident telephone lines, the system comprising:
a plurality of sensing circuits electrically coupled to the plurality of resident telephone lines, with each of the plurality of sensing circuits electrically coupled to a different telephone line;
a microprocessor for sampling current flowing through the each of the plurality of sensing circuits to determine if a telephone company central office is supplying an operating voltage to each of the plurality of resident telephone lines; and
an alternative power source for supplying an alternative operating voltage to any of the plurality of resident telephone lines not receiving the operating voltage from the telephone company central office.

2. The system of claim 1, wherein the microprocessor generates a control signal indicating the presence or absence of the telephone company central office operating voltage.

3. The system of claim 2, wherein the each of the plurality of sensing circuits comprise a voltage selection switch having a first position for connecting a resident telephone line to the central office operating voltage, and a second position for connecting the resident telephone line to the alternative power source.

4. The system of claim 3, wherein the control signal instructs the voltage selection switch to operate in the first position or the second position.

5. The system of claim 4, wherein each of the voltage selection switches includes a latching relay.

6. The system of claim 1, wherein the microprocessor controls the operation of the plurality of voltage selection switches based on signals received from the plurality of sensing circuits to assure proper timing of the switching.

7. The system of claim 6, further comprising a timer circuit for generating a timing signal input to the microprocessor.

8. The system of claim 7, wherein the microprocessor continuously samples the status of the telephone company central office service operating voltage at a predetermined sampling rate.

9. The system of claim 8, wherein the sampling rate is controlled by the timer circuit.

10. The system of claim 3, wherein the each of the plurality of sensing circuits further comprises a current to voltage converter for receiving a current signal from the telephone company central office and converting the current signal to a voltage signal; and a signal amplifier for amplifying the output voltage of the current to voltage converter.

11. The system of claim 3, wherein the microprocessor requires a pre-determined number of consecutive identical samples to initiate switching of the voltage selection switch.

12. The system of claim 11, wherein samples are taken every three seconds.

13. The system of claim 1, wherein the alternative power source comprises a 24V AC power supply connected to a DC converter power regulator.

14. A method for selectively connecting each of a plurality of telephone lines to a central office operating voltage or to an alternate power source operating voltage, the method comprising the steps of:
sampling each of the plurality of the telephone lines to detect the presence of the central office operating voltage at the each of the plurality of telephone lines:
connecting the alternative power source operating voltage to any of the telephone lines for which the central office operating voltage is not detected; and
reconnecting the central office operating voltage to any of the telephone lines that has been connected to the alternative power source upon detecting the presence of the central office operating voltage.

15. The method of claim 14, wherein the step of sampling the each of the plurality of telephone lines further comprises:
storing N consecutive sampling results for each telephone line sampled; and
switching between the alternative power source and the central office operating voltage only when all N samples are the same.

16. The method of claim 15, wherein a microprocessor samples the status of the central office service operating voltage at a predetermined sampling rate.

17. The method of claim 16, wherein the sampling rate is controlled by a timer circuit.

18. The method of claim 14, wherein the alternative power source comprises a 24V AC power supply connected to a DC converter power regulator.

19. The method of claim 16 wherein the microprocessor generates a control signal indicating the presence or absence of the central office operating voltage.

20. The method of claim 19, wherein a voltage selection switch connects a telephone line to the central office operating voltage when in a first position and to the alternative power source operating voltage when in a second position.
